(19) United States
(12) Patent Application Publication
(10) Pub. No.: US 2025/0171141 A1
(43) Pub. Date: May 29, 2025

(54) A Vertical Takeoff and Landing Assistance Aircraft using Fixed Angle Ducted Motors

(71) Applicant: SpyDar Sensors, Inc., Fairfax, VA (US)

(72) Inventors: Michael Andrew Johnson, Stafford, VA (US); Stuart Theodore Dana, Manassas, VA (US)

(21) Appl. No.: 18/520,999

(22) Filed: Nov. 28, 2023

(51) Int. Cl. B64C 37/02; B64C 11/00; B64C 29/00

(52) U.S. Cl. CPC B64C 37/02; B64C 11/001; B64C 29/0091

(57) ABSTRACT

The present invention provides a vertical takeoff and landing assistance aircraft which mates with deployable aircraft to assist the deployable aircraft with takeoff and landing. The assistance aircraft may incorporate the use of one or more multi-motor assemblies for enhanced aircraft performance. The vertical takeoff and landing assistance aircraft is designed to allow the deployable aircraft to be mated or fastened to the top portion of the assistance aircraft allowing a top release of the deployable aircraft. The assistance aircraft, upon deployment of the deployable aircraft, drops below the deployable aircraft. The assistance aircraft also includes one or more methods for deployment and recapture of the deployable aircraft.

### FIELD OF THE INVENTION

The present invention relates generally to aircraft and to vertical takeoff and landing aircraft (VTOL) or short takeoff and landing aircraft (STOL, collectively VTOL and STOL are referred to as VSTOL). More specifically, the present invention relates to an aircraft which can assist a second aircraft or deployable aircraft achieve VSTOL.

### BACKGROUND OF THE INVENTION

Enhancing aircraft performance, two critical metrics stand out: endurance and payload capacity. While Vertical Takeoff and Landing (VTOL) capability is indispensable across various market and mission scenarios, it poses a challenge to achieving prolonged endurance and accommodating heavier payloads. The fundamental issue arises from the inherent conflict between VTOL requirements and the need for extended flight and increased payload capacity.

The demand for VTOL operations necessitates an aircraft to either bear its VTOL propulsion system as non-functional weight during forward flight or endure design inefficiencies, especially noticeable in tilt-rotor aircraft due to power mismatches. This dichotomy emerges from the requirement for high thrust during takeoff and landing, in stark contrast to the lower thrust needed during forward cruise. Achieving high thrust demands a robust power plant onboard the aircraft. However, this setup is suboptimal for forward flight, where lower power suffices due to enhanced aerodynamic lift from wing-borne flight, thus rendering high-powered engines inefficient. Additionally, tilt-rotor designs face propeller mismatches, with the propeller optimized for vertical ascension proving inefficient for forward flight. The blunt VTOL design also contributes to increased parasitic drag during forward motion, further impeding efficiency.

The ideal solution entails an aircraft specifically designed for forward flight but equipped with VTOL capabilities, separating the VTOL operation from the primary forward flight functionality. Therefore, what is needed is a design which enhances the VTOL capabilities while not degrading the forward flight functionality of the aircraft.

### SUMMARY OF THE INVENTION

The present invention overcomes the limitations of known aircrafts and systems by providing a novel design approach that facilitates VTOL-Cruise flight through a two-stage process or two-part system. In the initial stage, a deployable aircraft is vertically or nearly vertically launched using a specialized Chariot System engineered for high-power, high-thrust launch and landing operations. The Chariot System is designed to mate with the deployable aircraft to assist the deployable aircraft. Once the Chariot System propels the deployable aircraft to its cruise speed and any required altitude, the Chariot disengages from the deployable aircraft and returns to the home station. Consequently, the deployable aircraft continues its journey at its optimal cruise speed without the additional weight or drag penalties associated with the cumbersome VTOL launch system (Chariot System). This innovative approach significantly extends the deployable aircraft's endurance capabilities or enables a substantial increase in payload capacity, marking a substantial leap in aviation design and functionality.

Further, the present invention provides a vehicle for assisting a deployable aircraft with vertical take-off and/or landing (VTOL), comprising: (1) a left pylon containing a plurality of left side multi-ducted angled rotors embedded in the left pylon; (2) a right pylon containing a plurality of right side multi-ducted angled rotors embedded in the right pylon; (3) a connecting truss connecting the left pylon to the right pylon. The connecting truss includes a lower planar bridge, a left side arm, and a right side arm, where the left side of the lower planar bridge is connected to a left arm lower end of a the left side arm and the right side of the lower planar bridge is connected to a right arm lower end of the right-side arm and the left arm upper end is connected to the left pylon, the right arm upper end is connected to the right pylon. Further, the connecting truss is located below a left side upper surface of the left pylon and a right-side upper surface of the right pylon to create an opening between the left pylon and right pylon which accommodates a deployable aircraft. The deployable aircraft mates with the left side upper surface of the left pylon and the right-side upper surface of the right pylon and a fuselage of the deployable aircraft fits within the opening between the left side pylon and right-side pylon. The vehicle of the present invention further comprising a connection device for connecting the deployable aircraft to the vehicle such as a hook and/or tether or a magnetic connection.

The vehicle of the present invention may also include a processing system, where the processing system controls the plurality of left side multi-ducted angled rotors and the plurality of right side multi-ducted angled rotors to control flight of the vehicle. The vehicle of the present invention may also include a communication unit for communicating with the deployable aircraft, a remote-control device, or a remote computer.

The vehicle of the present invention further comprising a left side planar mating surface on the left side upper surface of the left pylon and a right-side planar mating surface on the right-side upper surface of the right pylon where the left wing of the deployable aircraft mates with the left side planar mating surface of the left pylon and the right wing of the deployable aircraft mates with the right-side planar mating surface of the right pylon. Further, the lower planar bridge can be an expandable bridge having an extension bar or extension insert or the bridge can be modular such that a wider or shorter bridge piece can be used. The vehicle of the present invention can also comprise a left side riser connected to the left side upper end of the left arm, of the truss assembly, and the left pylon and a right-side riser is connected to the right-side upper end of the right arm, of the truss assembly, and the right pylon.

The vehicle of the present invention can be used to perform a vertical takeoff or landing with the deployable aircraft mated to the vehicle. Further, the vehicle of the present invention is designed and configured to drop away from the deployable aircraft when the deployable aircraft is released. The vehicle can also include a tether located between the left side pylon and right-side pylon for capturing the deployable aircraft in flight. The tether could be connected to the left and right-side pylons, risers, or the left and right arm of the truss assembly. The vehicle of the present invention does not need wings or control surfaces as flight can be controlled by the multi-ducted angled rotors.

The present invention also provides a method of releasing a deployable aircraft using a vertical takeoff vehicle the method comprising the steps of: (1) mating the deployable aircraft to the vertical takeoff vehicle by: (i) placing a left wing of the deployable aircraft on a left side upper surface of a left pylon of the vehicle; (ii) placing a right-side wing of the deployable aircraft on a right-side upper surface of a right pylon of the vehicle; and (iii) placing a fuselage of the deployable aircraft fits within an opening between the left side pylon and right-side pylon; where the left side pylon is connected to the right side pylon by a connecting truss below the left side pylon and right side pylon; where the left pylon contains a plurality of left side angled motors embedded in the left pylon; where the right pylon contains a plurality of right-side angled motors embedded in the right pylon; (2) initiating vertical takeoff of the vehicle by controlling the plurality of left side angled motors and the plurality of right side angled motors; (3) sensing, by at least one sensor, the altitude of the vehicle; (4) determining, by the vehicle, the altitude has achieved a pre-determined threshold; and (5) releasing the deployable aircraft by lowering the power provided by the plurality of left side angled motors and plurality of right-side angled motors allowing the vehicle to drop away from the deployable aircraft.

The method of releasing a deployable aircraft can further comprise the steps of claim 16, further comprising the steps of sensing, by the at least one sensor, an airspeed of the vehicle; and determining, by the vehicle, the airspeed has achieved a pre-determined threshold. Further, the release of the deployable aircraft can include releasing a connection device connecting the deployable aircraft to the vehicle. The plurality of left side angled motors and plurality of right-side angled motors could be multi-ducted angled rotors, fixed angled turbines, or could be comprised of both multi-ducted angled rotors and fixed angled turbines. Further, the release of the of the deployable aircraft could be based on receiving a communication signal by a communication unit of the vehicle and the communication signal could be from the deployable aircraft, a remote control, or a remote computer.

The present invention also provides a method of capturing or recapturing an aircraft in flight using a vertical landing vehicle the method comprising: (A) initiating vertical takeoff of the vehicle by controlling a plurality of left side angled motors embedded in a left pylon and a plurality of right-side angled motors embedded in a right pylon, wherein the left side pylon is connected to the right-side pylon by a connecting truss below the left side pylon and right side pylon; (B) controlling flight of the vehicle and at least one sensor of the vehicle to position the vehicle in front of and below the aircraft; (c) capturing the aircraft to the vertical landing vehicle in flight by: (i) mating a left wing of the aircraft on a left side upper surface of the left pylon of the vehicle; and (ii) mating a right wing of the aircraft on a right-side upper surface of the right pylon of the vehicle; and (iii) connecting the aircraft to the vehicle by a connecting device.

### BRIEF DESCRIPTION OF THE DRAWINGS

The present invention can be more fully understood by reading the following detailed description together with the accompanying drawings, in which like reference indicators are used to designate like elements, and in which:

FIG. 1 provides a sequence figure depicting the steps of release of a deployable aircraft using a first embodiment of the present invention;

FIG. 2 depicts a perspective view of the first embodiment of the aircraft of the present invention;

FIG. 3 depicts a perspective view of the first embodiment of the aircraft of the present invention mated with a deployable aircraft;

FIG. 4 depicts a top view of the first embodiment of the aircraft of the present invention mated with a deployable aircraft;

FIG. 5A provides a front view of a second embodiment of the present invention;

FIG. 5B provides a perspective view of a second embodiment of the present invention;

FIG. 6A provides a front cross-section view of a second embodiment of the present invention;

FIG. 6B provides a front cross-sectional view of a second embodiment of the present invention mated with a deployable aircraft;

FIG. 7 provides a system diagram chart illustrating system components of the of the aircraft of the present invention;

FIG. 8 provides a logic flow diagram of the steps for a release of a deployable aircraft using the aircraft of the present invention;

FIG. 9 provides a sequence figure depicting the steps of recapture of a deployable aircraft using the present invention;

FIG. 10 provides a logic flow diagram of the steps for a recapture of a deployable aircraft using the aircraft of the present invention;

FIG. 11 provides a top perspective view of a third embodiment of the present invention mated with an alternative deployable aircraft;

FIG. 12A provides a top view of a third embodiment of the present invention mated with an alternative deployable aircraft;

FIG. 12B provides a cut away cross sectional view of a third embodiment of the present invention mounted on an alternative deployable aircraft;

FIG. 13 provides a cross-sectional view of a pylon displaying turbines in a fixed forward position;

FIG. 14 provides a cross-sectional view of a pylon displaying the use of turbines and multi-ducted angled rotors in a fixed forward position;

FIG. 15 provides front cross-sectional view of an additional embodiment showing the pylon connection to the truss assembly incorporating a mounting plate with an angle; and

FIG. 16 provides a perspective view of an additional embodiment showing the pylon connection to the truss assembly incorporating a mounting plate with an angle.

### DETAILED DESCRIPTION

Hereinafter, aspects of the design, associated systems, and methods of making, assembly, or use are described in accordance with various embodiments of the invention. As used herein, any term in the singular may be interpreted to be in the plural, and alternatively, any term in the plural may be interpreted to be in the singular. It is appreciated that features of one embodiment as described herein may be used in conjunction with other embodiments. The present invention can be more fully understood by reading the following detailed description together with the accompanying drawings, in which like reference indicators are used to designate like elements.

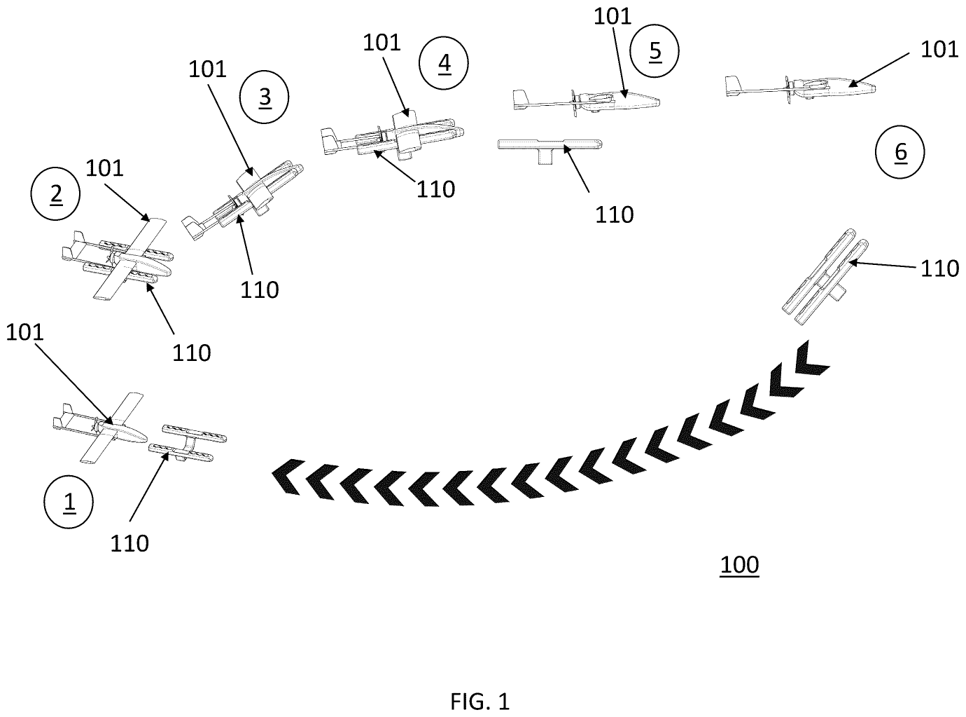

As illustrated in FIG. 1, the present invention provides a support aircraft 110 (referred to herein as a “Chariot”) which assists a deployable aircraft 101 (referred to herein as “DAC”) achieve VTOL/STOL operations. The unique design of the Chariot 110 allows the DAC 101 to be mated with the Chariot 110 to assist the DAC achieve altitude and speed and then be deployed. The various steps of the deployment are illustrated in FIG. 1 and described herein.

### Step One: Secure Connection.

The process is initiated by establishing a secure connection between the DAC 101, which is typically a fixed wing platform, and the Chariot 110. In a first embodiment, the connection is facilitated through a robust hook and latch mechanism, ensuring stability between the DAC 101 and Chariot 110 with three points of contact. The three points of contact will be described in further detail herein.

### Step Two: Preflight Check

As typical for aircraft, prior to takeoff a preflight check should be conducted. This comprehensive assessment involves a series of standard checks for both the DAC 101 and the Chariot 110, guaranteeing their airworthiness. Once the system passes these checks, it is armed and stands ready for takeoff.

### Step Three: Vertical Takeoff

A vertical takeoff with the Chariot 110 system with the mated DAC 101 beings upon initiation of a takeoff signal (described in more detail below) which powers or initiates the use of a plurality of multi-ducted angled rotor (M-DAR) units embedded within the Chariot 110. Upon powering of the M-DARs in the Chariot 110, the Chariot and mated DAC ascend to a safe altitude that sets the stage for a seamless transition into forward flight. As depicted in Step 3, the Chariot 110 is typically in a nose up position while gaining altitude. Step three ensures a controlled and secure vertical lift-off (VTOL), laying the foundation for the subsequent maneuvers.

### Step Four: Transition to Forward Flight

Once the Chariot 110 and mated DAC 101 have reached an optimal altitude (step 3), the entire system efficiently adjusts its orientation by pitching nose down (from a nose up position) to achieve a level flight position. The M-DAR units are angled forward allowing for both vertical takeoff and forward flight. The Chariot 110 utilizes the M-DAR platform to propel the system forward. The Chariot 110 system aligns itself, gradually matching the optimal forward flight speed of the DAC 101.

The Chariot 110 with the mated DAC 101 can rapidly gain altitude and forward flight speed. The preferred altitude may depend upon the mission of the effort. For example, if the launch is in an urban environment, then a more vertical takeoff or altitude gain is needed to be achieved before gaining significant forward flight speed. However, if the launch is from a boat or unobstructed location, then it might be preferable to gain forward flight speed as quickly as possible with limited altitude gain. Ultimately, the mission or operation of the DAC 101 and the launch terrain will dictate the release criteria related to altitude and airspeed.

### Step Five: Speed Confirmation and Craft Separation

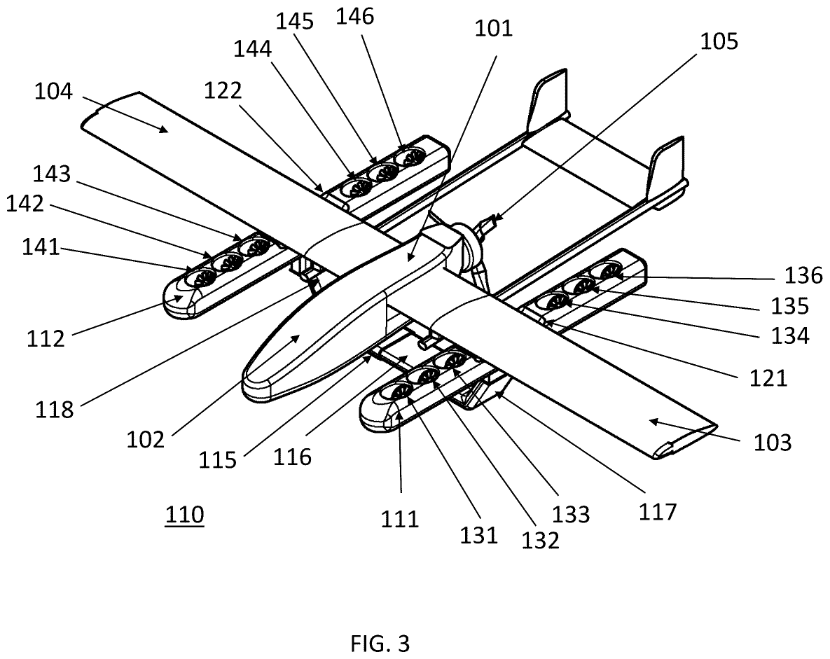

In step 5, the system confirms the achieved speed using an airspeed sensor. Simultaneously, the pusher 105 (see FIG. 3, 4) on the DAC 101 begins to spool-up at low RPM. Upon reaching this critical stage, the release mechanism of the Chariot 110 engages, ensuring a controlled separation of both the Chariot 110 and DAC 101. As this occurs, the Chariot 110 lowers its throttle of the MDARs, allowing the Chariot 110 to descend below the DAC 101 as the DAC 101 seamlessly transitions into forward flight.

### Step Six: Mission Deployment and Return

As seen in step 6, with the DAC 101 now detached, it embarks on its designated mission. Meanwhile, the Chariot 110 gracefully transitions back into an operation or hover position and begins its return to home or the takeoff location. The versatile Chariot 110 system is now ready to potentially undertake the same mission on other aircraft with efficiency and precision.

### Chariot Design

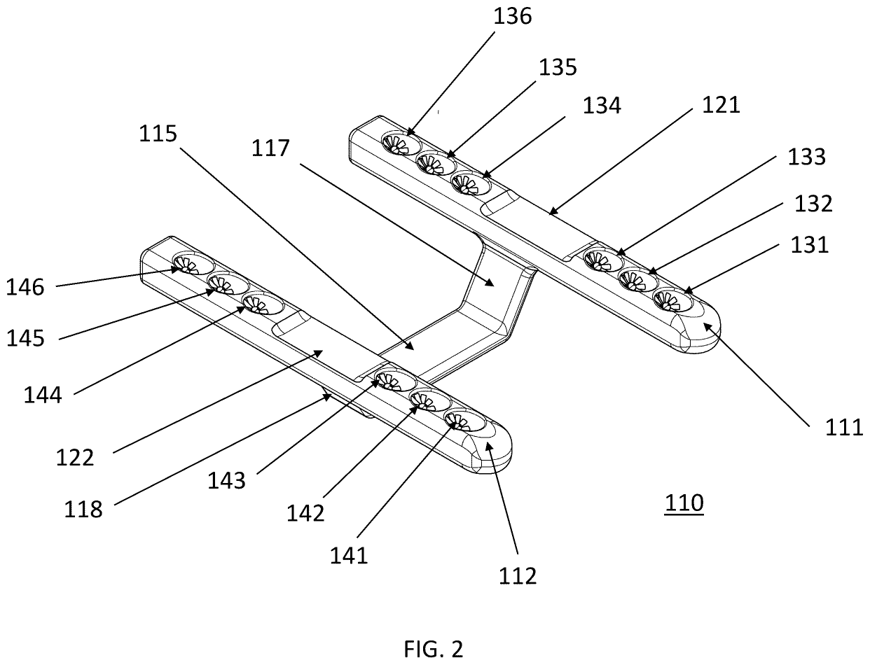

As seen in FIG. 2-4, the Chariot 110 includes two nacelles or pylons 111, 112 which are connected by a truss system under the pylons 111, 112. The truss system includes a horizontal bridge 115. The bridge 115 is connected to a left side arm 117 and a right-side arm 118 (from the perspective of a pilot or forward flight) forming a general U shape. The left side arm 117 is connected to the left side pylon 111 and the right-side arm 118 is connected to the right-side pylon 112. The arms 117, 118 may be angled, as depicted in FIG. 2, or vertical. The arms 117, 118 may be connected to the underside of pylons 111, 112 or connected to an inside or outside wall of pylons 111, 112.

As seen in FIG. 2, the pylons 111, 112 contain a plurality of M-DAR units. The left pylon 111 contains one or more M-DAR units 131, 132, 133 embedded in a front portion of the left pylon 111 and one or more M-DAR units 134, 135, 136 embedded in a rear portion of the left pylon 111. The right pylon 112 contains one or more M-DAR units 141, 142, 143 embedded in a front portion of the right pylon 112 and one or more M-DAR units 144, 145, 146 embedded in a rear portion of the right pylon 112. The left pylon 111 has a recessed planar wing mating surface 121 for receiving and mating with a left wing of the DAC 101. The right pylon 112 has a recessed planar wing mating surface 122 for receiving and mating with a right wing of the DAC 101.

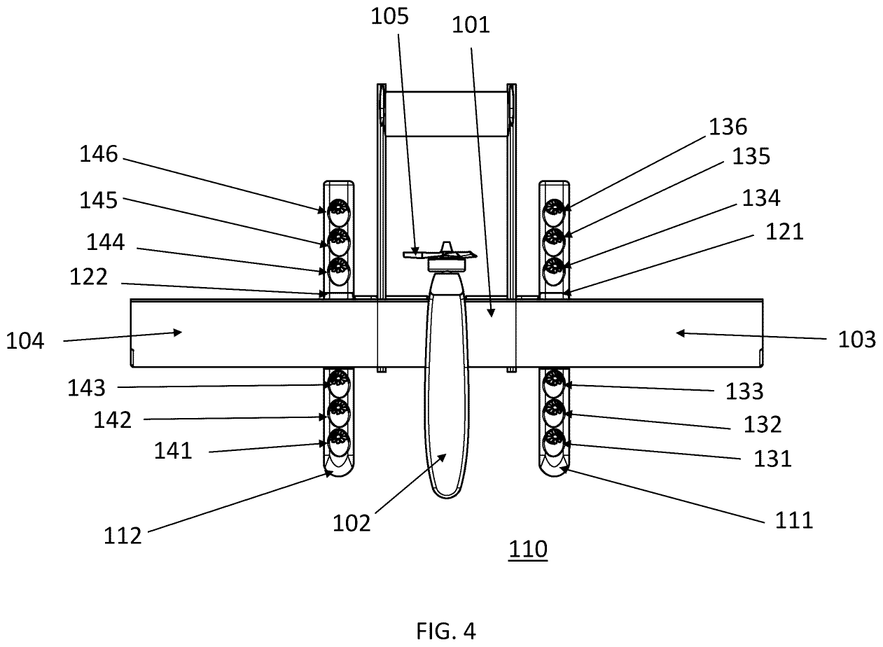

As seen in FIGS. 3 and 4, the DAC 101 mates in an upper or top position on the Chariot 110. The fuselage 102 of the DAC 101 rests within the void or open space created by the Chariot 110 truss system (bridge 115 and arms 117, 118) and the left and right pylons 111, 112. The left wing 103 of the DAC 101 rests on the left side wing mating surface 121 and the right wing 104 of the DAC 101 rests on the right-side wing mating surface 122.

The benefit of a top loaded DAC 101 is that the DAC 101 is launched above the Chariot 110 as the Chariot 110 drops away from the DAC 101. A top launched DAC 101 provides two significant benefits among a plurality of benefits. First, as the Chariot 110 can move in both a vertical and forward direction, the DAC 101 can be put into operation and released ready to operate (i.e., ready to fly or in flight on its own unassisted). Thus, an upper deployment minimizes or removes the risk of the DAC 101 being deployed in an inoperative state and hoping it will turn on and operate. Second, the impact of any turbulence or pressure effects from the Chariot 110 are dramatically reduced. As the Chariot 110 is dropped away from the DAC 101 by stopping or dramatically reducing the power or airflow of the M-DARs 131-136, 141-146 there is little turbulence impacting the DAC 101. In contrast, a hover or similar aircraft which releases the DAC 101 below the hover or similar craft (i.e., a drop release) will exert significant air pressure and turbulence on the top of the wings 103, 104 of the DAC 101 at release as the hover craft needs to stay above the DAC 101 at release to avoid colliding with the DAC 101. This air pressure and turbulence caused by a hover or similar aircraft above the DAC 101 will cause significant detrimental conditions at release or launch forcing the DAC 101 to overcome at a critical time when the DAC 101 is powering up and attempting to fly on its own.

In the preferred embodiment, the Chariot 110 utilizes a plurality of M-DARs 131-136, 141-146. The M-DAR units 131-36, 141-146 are typically placed within the nacelles or pylons 111, 112 with a corresponding M-DAR unit in the same or a similar location on the opposite nacelle 111, 112. For example, M-DAR 131 in the left nacelle 111 has a corresponding M-DAR 141 in the right nacelle 112. The corresponding M-DARs help to maintain balance or stability of the Chariot 110 during VTOL, STOL, or forward flight. The M-DAR units 131-36, 141-146 also typically have front and rear balance for example MDAR unit 131 and 136 (or 141 and 146) which helps maintain balance or stability of the Chariot 110 aircraft to control pitch.

The M-DAR units 131-36, 141-146 are positioned or embedded within the housing of the pylons 111, 112 in a pitch forward position typically between 30-70 degrees with most designs setting the forward position at 45-65 degrees from the horizontal. Fixing the ducts of the M-DAR units at less than a 90-degree angle improves airflow through the ducts as the air has less angle to overcome than a 90-degree (or vertical) planar ducted fan design. The lower momentum drag of the M-DAR design enables the fans to operate at a higher forward flight transition speed. The M-DAR technology provides VTOL designs, and dramatically expands the existing mission envelope of typical aircraft by increasing speed and maneuverability.

In a preferred embodiment, the M-DAR electric ducted fans are enclosed into a forward aligned aerodynamic body (i.e., the pylons 111, 112) and pitched forward. The ducts increase airflow over the front lip of the pylons 111, 112 which creates induced lift on the front of the Chariot 110. The angle of the M-DARs also aid in the flow of air into the ducts of the M-DARs at higher speeds, decreasing the risks of stalled airflow over the front ducts.

The control system of the Chariot 110 is designed to constantly read and adjust the power of each M-DAR unit 131-36, 141-146 to achieve the desired performance (VTOL, STOL, forward flight) as well as control the stability related to roll and pitch. Such control includes stable flight, banks or turns, ascent or descent as well as other actions typically needed during flight. The controls can be managed remotely via communications such as in an unmanned Chariot 110 or can work with an operator in the cockpit of the DAC 101. Further, the controls could be a combination of both remote control and operator control. The controls also offer safety redundancy such that if an M-DAR unit 131-36, 141-146 were to fail, the control system could shut down the corresponding M-DAR unit 131-36, 141-146 and still use the remaining M-DAR units 131-36, 141-146 to control flight required performance.

The Chariot 110 can incorporate use of a flight controller consisting of a gyroscope and accelerometer. Often the controller includes a compass, Global Positioning Device, and airspeed sensor. The flight controller maintains a vectored heading by manipulating the rotational speed or blade pitch of each individual M-DAR fan in the Chariot 110. The flight controller could implement a control system such as an error-based Proportional Integral derivative loop to maintain the stability of the Chariot 110. The controller accounts for a hover scenario of the Chariot 110 by setting the flight angle to be level plus the pitch angle of the ducts. This means the aerodynamic duct housing body (pylons 111, 112) is pitched up at that specified angle during hover or VTOL. The controller can also maintain level flight at the angle when the bottom of the aerodynamic lifting body is level to the horizontal and perpendicular to the airflow or direction of travel. The result is that the vehicle is in a constant state of transition. Stall speed or minimum speed can therefore be eliminated from consideration by the control system. The result is an extremely agile Chariot 110.

### Expandable Bridge—Truss

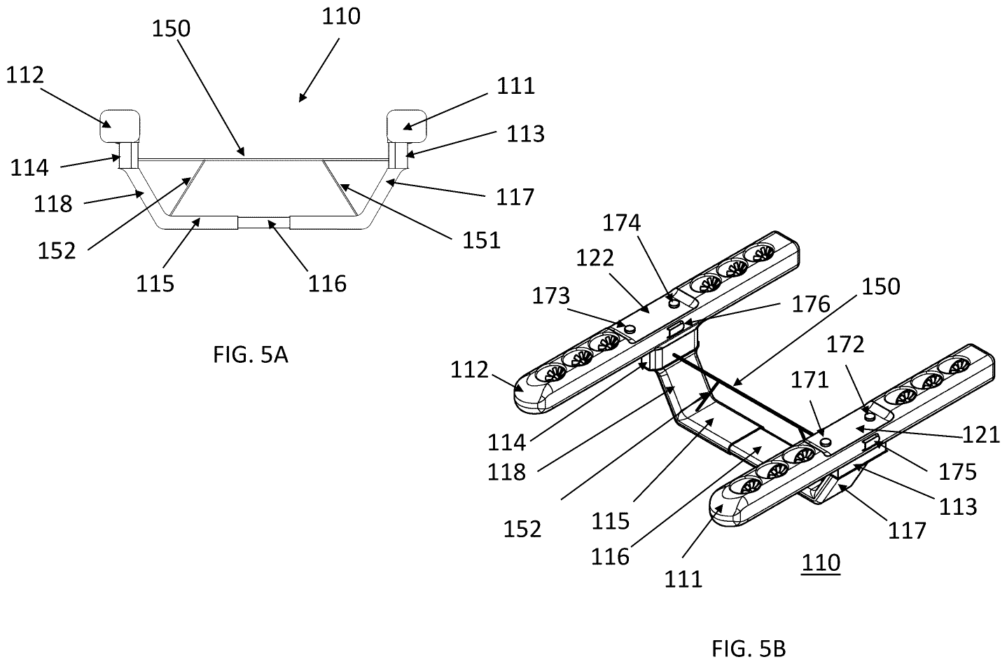

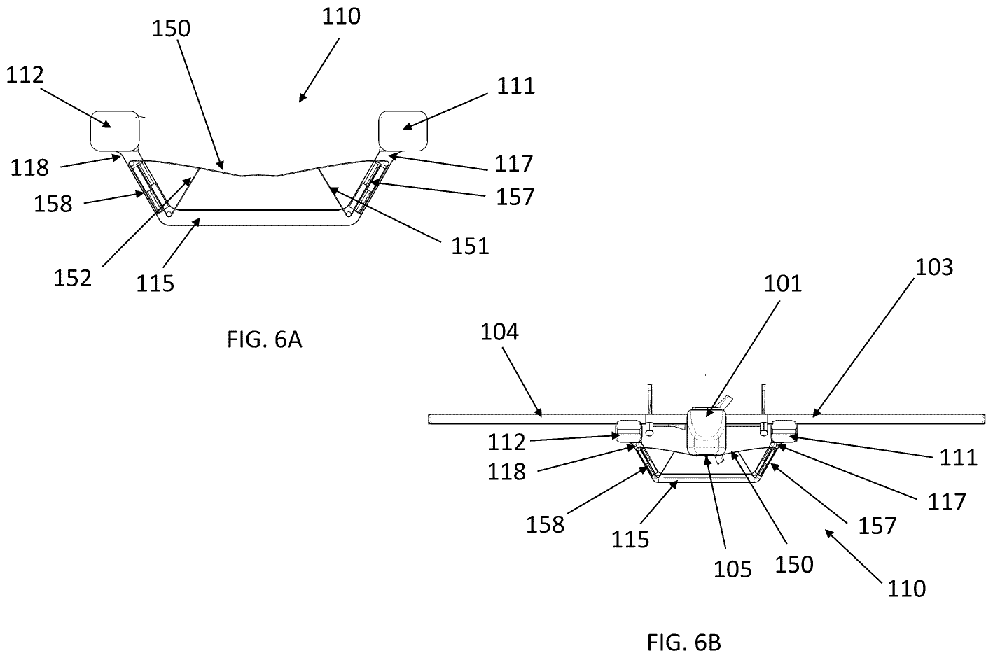

An additional embodiment of the Chariot 110 is seen in FIGS. 5A, 5B, 6A, and 6B. As the Chariot 110 may need to accommodate DACs 101 having different sizes the Chariot 110 can expand. Particularly, the bridge 115 can incorporate or include an inner mechanical extender or extender 116 which allow the bridge 115 to expand wider to accommodate wider DACs 101. Such extender 116 could be one piece or multiple pieces such as one or more rods and could have a mechanical lock to fix the extender 116 and bridge 115 as a set length of width. Further, the left arm 117 and right arm 118 could also have extenders or could use spacers 113, 114 with varying heights to accommodate DACs 101 with a taller fuselage 102.

In addition, the Chariot 110 can employ a tether system 150 capturing a DAC 101 in flight or could also use the tether system 150 as a mechanism for holding the DAC 101 to the Chariot 110. In an exemplary embodiment, the tether system 150 (see FIG. 6A) may contain one tether cord where the cord 150 is routed through a left side tensioner 157 and right-side tensioner 158 and then the left end 151 of the tether 150 is reconnected to the tether 150 and the right end 152 is reconnected to the tether 150. The tether 150 may be connected to the risers 113, 114 (see FIG. 5A), or if risers are not utilized, directly to the left and right-side arms 117, 118 (see FIG. 6A). The tensioners 157, 158 are used to create slack (as seen in FIG. 6A) in the tether 150 such as may be needed during recapture of a DAC 101 or to tighten the tether 150 once the DAC 101 is captured and need to hold the DAC 101 tightly to the Chariot 110. As seen in FIG. 6B, once the DAC 101 is recaptured, the DAC 101 is brought into a mated position with the Chariot 110 with the left wing 103 resting on the left pylon 111 and right wing 104 resting on the right pylon 112. As previously described, the left wing 103 could rest within the left-wing mating surface 121 and the right wing 104 could rest within the right-wing mating surface 122.

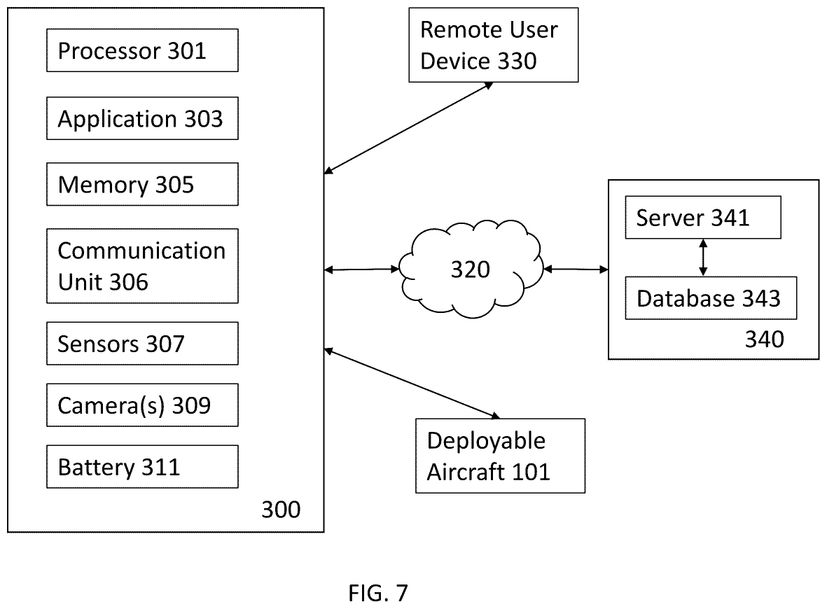

The Chariot 110 can employ various computing and communication components to facilitate the flight controls and releasing and recapture of the DAC 101. As seen in FIG. 7, the processing system 300 of the Chariot 110 can include a processor unit 301, and application or software unit or component 303, memory 305, a communication unit 306, one or more sensors 307, one of more cameras 309, and one or more power or battery units 311. The processor 301 can process or run the application or software 303 stored in memory 305. The memory 305 may also store various data for use by the processor system 300 such as the required flight or release criteria for the DAC 101 being deployed. Further, the sensors 307 and cameras 309 can be used by the processor system 300 to determine real-time sensed data such as altitude, air speed, alignment, distance (from the ground or from the DAC 101), pitch, yaw, or related flight characteristics. The Communication unit 306 can be used to communicate with a remote user device 330 (such as a remote-control unit), the DAC 101, or to a remote computer or server system 340. The remote server system 340 may contain one or more computers or server 341 connected to one or more databases 343. Connection to the remote user device 330 or DAC 101 would be wireless and may be by radio frequency, Bluetooth, Wi-Fi or other communication technology. Connection to the remote server system 340 would also be wireless and may also be by radio frequency, Bluetooth, Wi-Fi or other communication technology but would most likely be by Wi-Fi via the internet 320.

The Communication unit 306 would ideally be a transceiver capable of sending and receiving communication signals. Thus, the Chariot 110 would be capable of sending data, receiving data, and receiving instructions in a remote-controlled deployment. Further, the Chariot 110 or DAC 101 could communicate during deployment or recapture of the DAC 101 to verify the DAC 101 is ready to be deployed or recaptured (including alignment during recapture).

The processor system 300 also controls the M-DAR units 131-36, 141-146 to maintain flight controls of the Chariot 110. The batteries 311 can be used to power the M-DAR units 131-36, 141-146, the processing system 300, the tether system 150, and other systems described herein. The batteries 311 or power to the various units can also be controlled by the processor system 300. The processor 301 could be a computer processing unit or a microprocessor.

### Deployment Logic

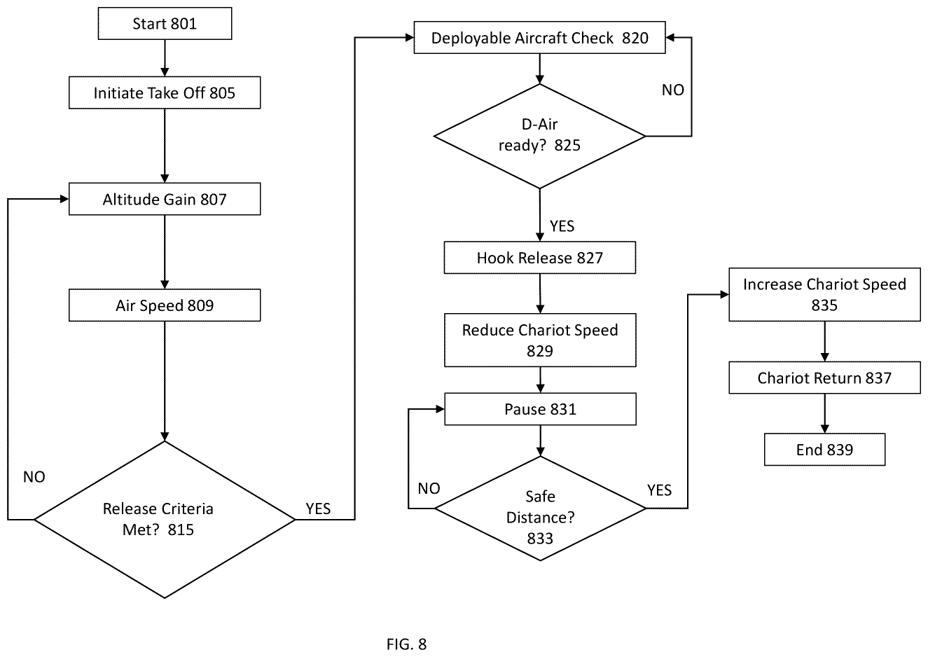

The system logic for deployment or release of a DAC 101 from the Chariot 110 is depicted in FIG. 8. As previously described with reference to FIG. 1, the release of a DAC 101 has multiple steps. However, the system logic includes several logic steps not previously discussed or described in FIG. 1. To deploy the DAC 101, the Chariot 110 and DAC 101 are connected and ready to start the deployment process, step 80. The Chariot 110 receives a signal to initiate takeoff in step 805. Upon the initiate takeoff step 805, the M-DAR units 131-36, 141-146 are powered on. In step 807, the M-DARs are powered to a level which allows the Chariot 110 and mated DAC 101 to gain altitude to a threshold or predetermined altitude. Ideally, the Chariot 110 with the DAC 101 mated will ascend vertically between 40 and 90 degrees after takeoff. The most likely angle of ascent will be between 60 and 75 degrees from the horizontal. Once the predetermined altitude is obtained, the Chariot 110 in step 809, levels off and increases forward aid speed until a threshold or predetermined airspeed is reached.

In step 815, the system determines if the release criteria are met. The criteria being the altitude and air speed but could include other criteria. If the criteria are not met, the system loops back to gaining additional altitude (step 807) or airspeed (step 809). If the release criteria in step 815 have been met, the system in step 820 checks the status of the DAC 101. The DAC check includes checking to make certain the DAC pusher 105 (of fan or propeller) is on and the DAC system is working. The system, in step 825 determines if the DAC is ready. If not, the system reverts back to the DAC check (step 820) and the Chariot 110 or remote user(s) can communicate with the DAC 101 to determine what aspects are not ready. Step 820 and 825 are important to make certain the DAC 101 is ready for self-flight prior to deployment.

If, in step 825, the DAC 101 is ready for deployment, the system flows to step 827 and the hook, or other fastening system, is released. Next, in step 829, power to or fan speed of the M-DAR units 131-36, 141-146 of the Chariot 110 is reduced causing the Chariot to both lose altitude and airspeed and drop away from the DAC 101. As the Chariot 110 drops away, the DAC 101 is now deployed for its mission. The Chariot 110, in step 831, pauses to allow sufficient time to drop away from the DAC 101. In step 833, the system then determines if the Chariot 110 is a safe distance from the DAC 101. If not, the system reverts to an additional pause. If the Chariot 110 determines it is a safe distance away from the DAC 101 the system then proceeds to step 835 where it powers the M-DAR units back up to an appropriate power or fan speed level for self-flight. In step 837, the Chariot 110 then returns to the takeoff spot or another location. Once landed the Chariot 110 can be powered down and the process ends in step 839.

The flight controls and release controls can be manually controlled by a remote-control device, controlled by a user, or could be programmatically controlled by a computer. Further, because the Chariot 110 and DAC 101 can communicate with each other, the deployment could be controlled by the Chariot 110 or by the DAC 101.

### Plane Lift Sensor Array

The Chariot 110 could also include load sensors or cells. The load sensors or cells would be located on the planar wing mating sections 121, 122. As the wings 103, 104 of the DAC 101 begin to generate enough of their own lift that the DAC 101 can fly without assistance, the load sensors would detect a lack of load or reduced load. Upon detection of a reduced load, the Chariot 110 would then unhook the DAC 101, reduce power to the M-DAR units 131-136, 141-146 and drop away from the DAC 101 thus deploying the DAC 101.

system, we have developed a hypothetical method that could determine when the plane has generated enough lift for the plane to fly on its own. The advantage of this means all the chariot would need to do is stall its ducts and release the drone. The load cells or sensors would be placed at all points of DAC 101 contact and basic mounting. The load cells or sensors could use analog signals which would be processed using as many Analog Digital Converters as load cells or sensors. The analog digital converters could be connected to a single Arduino which will average multiple data points to smooth the signal then write the signals and transmit to the flight controller to send telemetry data back to the remote controller or radio. The output could then be processed to a single number which is the net and or total lift of the Chariot 110 or DAC 101.

An additional system could use a combination of load cells 171, 172, 173, 174 and strain gauges 175, 176 (see FIGS. 5B) easily mounted to the Chariot 110. The load cells 171, 172, 173, 174 would be mounted to the planar wing mating sections 121, 122. This additional system could use a minimum of 3 gauges (i.e., load cells 171, 173 and strain gauge 176) depending on mounting choices with a recommended number of 5 or 6 gauges. The planar wing mating sections 121, 122 would have one or more gauges 171, 172, 173, 174 on each planar wing mounting section 121, 122. These top gauges 171, 172, 173, 174 would be configured to act as a scale while an additional gauge or gauges 175, 176 (i.e., a strain gauge) could be mounted on the side of one or both the pylons 111, 112 to create a load cell or strain gauge to determine or indicate load in the y direction.

### Static Locking Systems

The Chariot 101 can also use a mating or locking system with the DAC 101 with no moving parts. The advantages are lower maintenance and no actuators (i.e., a hook) that can jam. Additionally, the Chariot 110 can also utilize multiple systems in tandem to mate the Chariot 110 and DAC 101.

For example, the Chariot 110 could use hooks, bumps, or indentations on the back of the Chariot 110 where the DAC 101 would rest. The Chariot 110 would need to avoid sudden downward accelerations to prevent the DAC 101 from slipping out of the hooks or indentations. Additionally, or alternatively, the Chariot 110 could use electromagnetic locks with a paramagnet. A key advantage of the paramagnet is both the ability to magnetically mate the DAC 101 to the Chariot 101 as well as reverse the direction of the magnet to help force separation of the Chariot 110 and DAC 101. Direction of the magnetic field can be inverted using an H-bridge to assist deploying the DAC 101 at release. The H-bridge can also be used to vary the strength of the field to conserve energy if it utilizes the load cells data to know if the DAC 101 is weighted. The DAC 101 would have corresponding metal plates to engage with the magnets on the Chariot 110. The magnets on the Chariot 110 would most likely be located on the planar wing receiving mating surfaces 121, 122 and the DAC 101 would have metal plates on the underside of the wings 103, 104.

An additional system could be an Air Pressure system. As the Chariot 110 uses multiple ducted fans (M-DARs) on each pylon 111, 112 a port on the intake side of the inner ducted fans can be added and run to or be ducted to the underside of the planar wing mounting section 121, 122. This would create a low-pressure area or suction effect under the wings to help keep the wings in the cradle or recess of the planar wing mounting section 121, 122. A key advantage to the air pressure system is it produces this suction without increasing the power consumption of the M-DAR units 131-136, 141-146 of the Chariot 110. This additional airflow can also be used to help cool the electric speed controls of the Chariot 110. Further, the M-DARs 131, 141, 136, 146 in the front and rear of the pylons 111, 112 have more authority than the M-DARs 133, 134, 143, 144 in the interior locations of the pylons 111, 112.

### Recapture

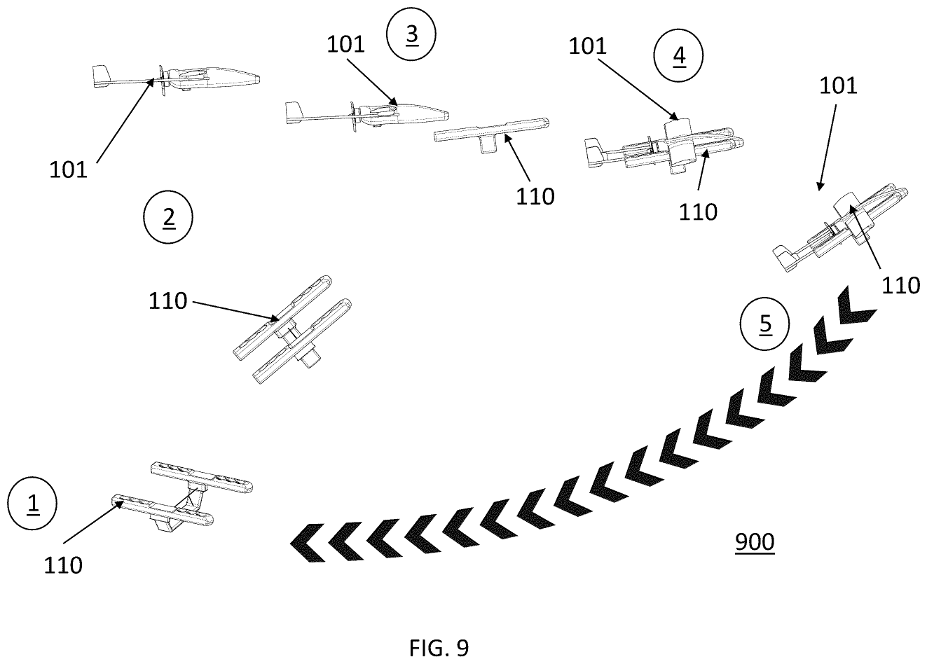

The Chariot 110 is also capable of recapturing the DAC 101 the steps of which are depicted in and described in conjunction with FIG. 9. In step 1, the DAC 101 is directed to a designated rally location and the Chariot 110 is prepared to deploy. The DAC 101 will enter a strategic loiter flight pattern in close proximity to the intended landing area, optimizing its readiness for the subsequent phases.

In step 2, the Chariot 110 takeoff is initiated and the Chariot 110 climbs in altitude and synchronizes its altitude and airspeed with the DAC 101. The Chariot 110 leverages GPS for initial proximity and can employ an airspeed sensor and an optical IR system for fine adjustments in aligning the heading of both the Chariot 110 and the DAC 101.

In step 3, the Chariot 110 is aligned directly in front of the DAC 101, matching its airspeed closely. Employing a GPS, airspeed sensor, and optical IR system for guidance, the Chariot 110 meticulously maneuvers for the docking phase. The IR sensors would be used for alignment and would most likely be mounted on the back of the pylons 111, 112 with an optical sensor mounted on the DAC 110 to align the Chariot 110 to a point of reference.

The DAC 101 can be equipped with a clamping mechanism for securing itself onto a cable or tether 150 attached to the Chariot 110. The clamping mechanism and tether 150 establishes a secure connection with three points of contact (left wing, right wing, and clamp to tether 150), ensuring stability and reliability. The Chariot 110 can utilize a spring-loaded loop with the cable or tether 150 (see FIG. 6A) for stress relief and for maintaining tension throughout the recapture process. Alternatively, the recapture or docking could be handled by the electromagnet system previously described.

In step 4, the DAC 101 is now securely attached to the Chariot 110 and transitions to the Chariot 110 controlling flight of the combined aircraft. The DAC 101 may be powered down so that the pusher 105 is no longer providing forward power, and the Chariot is transitioned into a hover, facilitating the safe transport of the DAC 101. The Chariot 110, now carrying the DAC 110 navigates to the predetermined landing zone. In step 5, the Chariot then ensures a controlled and secure descent. This systematic approach employed by use of the Chariot 110 guarantees the safe return and deployment of the DAC 101 fixed wing platform with precision and efficiency.

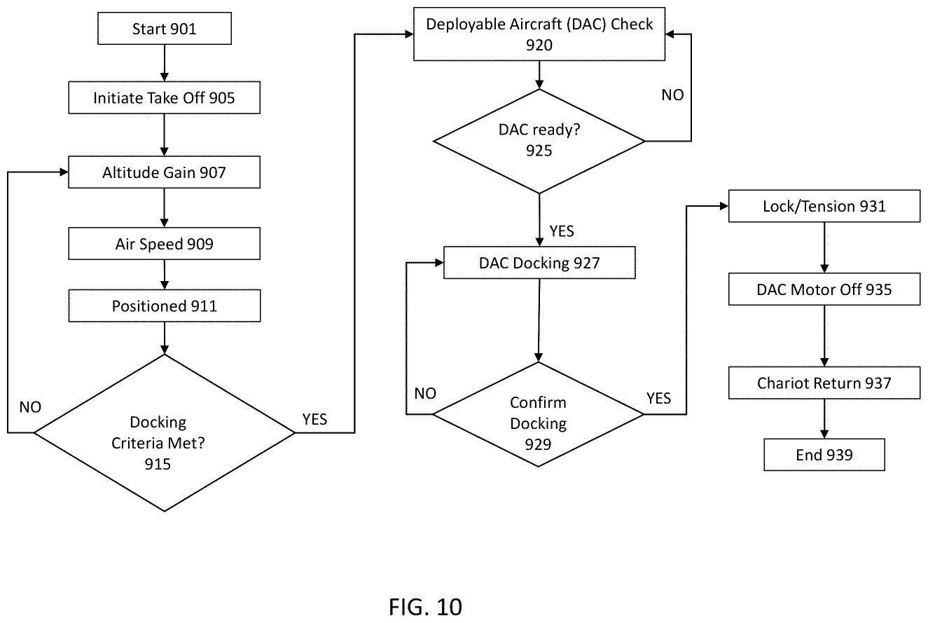

The system flow logic of the recapture process will now be described in conjunction with FIG. 10. The recapture process is started in step 901. The Chariot 110, in step 905, is initiated with power being provided to the M-DAR units 131-136, 141-146 until the Chariot 110 lifts off. In step 907, the Chariot 110 gains altitude and in step 909 the Chariot 110 gains air speed. In step 911, the Chariot 110 is positioned in front of the DAC 101 using the GPS, air speed sensor and IR system.

The system, in step 915, determines if the docking criteria is met. If not, the process reverts back to steps 907 to 911 to determine if additional altitude, air speed or positioning is needed. If, in step 915, the docking criteria is met the system proceeds to step 920 and performs a check of the DAC 101. The system then determines, in step 925, if the DAC 101 is ready to proceed to docking. If not, the system reverts to step 920 to check the DAC 101 again until the DAC 101 is ready. If the system, in step 925, determines the DAC 101 is ready to dock the system proceeds to step 927 and the DAC 101 is docked onto or with the Chariot 110. The docking in step 927 may include the hook on the DAC 101 capturing the tether 150 on the Chariot 110. Next, in step 929, the system confirms successful docking of the DAC 101 onto the Chariot 110. If the DAC 101 is not fully docked, the system reverts to step 927 to repeat the docking process. In step 929, if the system confirms docking the system moves to step 931. In step 931, the mechanical lock of tether tension is tightened to fully secure the DAC 101 to the Chariot 110.

In step 935 the motor to the pusher 105 of the DAC 101 can be turned off so that the pusher 105 does not import forces on the Chariot 110 while operating the mated units. Next, in step 937, the Chariot 110, including the M-DAR units 131-136, 141-146, operate to return the Chariot 110 and mated DAC 101 to the determined landing spot in a VTOL/STOL landing procedure.

### Chariot Remains Attached Deployment

An alternative approach to the release and recapture of the DAC 101 by the Chariot 110 system would be to leave the Chariot 110 attached to the DAC 101. In this scenario, the Chariot 110 can be used to assist the DAC 101 with its mission, which may include additional VTOL/STOL procedures. For example, if the mission of the DAC 101 is to travel to a remote location and land in a setting which requires a VTOL/STOL landing, and perhaps a subsequent VTOL takeoff. Or, if the mission is to travel and land to a location that doesn't have a receiving Chariot 110 system. Since the Chariot 110 provides an aerodynamic design, long slender pylons 111, 112, and additional propelling units such as the M-DAR units (131-136, 141-146) which can provide additional functionality. By integrating the Chariot 110 with the DAC 101, The combined aircraft can achieve a highly maneuverable and adaptable system suitable for various VTOL situations. While this may not result in the most efficient VTOL platform, it offers exceptional adaptability, especially in handling a wide range of center of gravity adjustments. In ship-to-shore operations, this configuration could provide an ideal electric approach, offering a controlled and reasonably efficient VTOL platform with a middle-of-the-lane capability.

### Addition Design Features of the Chariot

The aerodynamic design of the pylons 111, 112 are designed to have a minimal forward profile including through the design of an aerodynamic nose. In an exemplary embodiment, the pylon 111, 112 design is configured to ensure that the blades of the fan or motor within the M-DAR units 131-136, 141-146 are fully embedded in the housing of the pylons 111, 112. The pylons 111, 112 are designed to counter negative effects of unwanted moment forces caused by the Bernoulli effect, wind turbulence, unwanted velocity differential of air speed between the top and bottom of the pylons 111, 112 including airflow interference between the M-DARs 131-136, 141-146 in series and any issues related to the front duct in the series pulling air into it (and the impact that has on available air to the M-DAR units behind the front M-DAR unit).

The M-DAR units 131-136, 141-146 consist of three main elements in the basic design including: (1) the fan or propeller blades; (2) a motor or driveshaft; and (3) a stator. For clarity, a duct is the channel created in the housing for each M-Dar 1131-136, 141-146 which starts at the intake of each duct and terminates at the exhaust of each duct. Each duct in the housing is separated by walls to form separate ducts for each M-DAR 131-136, 141-146.

In the center of the ducts is a motor connected to one or more motor mounts. The motor may be a brushless DC motor attached to that mount by screws or some other attachment method. Attached to the motors is a fan consisting of several blades. The blades may be fixed pitch or variable pitch. The tips of the blade are separated from the duct walls by a thin gap, ideally as close to the duct wall without touching.

The use of M-DAR units 131-136, 141-146 in the Chariot 110 provides significant performance improvements. Such improvements, abilities, or differentiating aspects include: (1) a High Lift/Drag (CFD reports 27:1 at 60 knots); (2) simpler than a tilt-rotor; (3) lower weight than a tilt-rotor; (4) easier maintenance than a tilt-rotor; (5) a design which does not suffer downwash onto the wings like a tilt-rotor; (6) highly maneuverable; (7) able to achieve power flight by flight control command vs. actuating the rotors; (8) ducted fans can be quieter (focused sound); (10) quicker launch and landing than a tilt-rotor; (11) higher speeds possible; (12) butterfly enclosure of some of the intakes can be employed to reduce drag; (13) able to roll, pitch, and yaw using just differential thrust; and (14) eliminates the need for control surfaces or makes them redundant.

The use of M-DARs 131-136, 141-146, also referred to as electric ducted fans (“EDF”) has many advantages over other VTOL solutions. Ducted fans are mechanically simple compared to turbine engines, and helicopter systems. EDFs only have one moving part and the motors are more easily serviceable or replaceable, cutting maintenance cost and increasing reliability, and mission readiness of the system. EDFs also have a faster spin up and higher dynamic range than other distributed electric systems like conventional multirotor systems. EDFs also have a higher disk loading, producing significantly more thrust. EDFs have an increased mass flow rate which at higher airspeeds increases the maximum speed of a VTOL aircraft with the VTOL propulsion contributing additional lift. The relatively small size of EDFs allow the parallelization of M-DAR ducts along the length of an aerodynamic body increasing redundancy by creating a distributed electric VTOL system.

The aircraft 100 leverages the significant advantages of distributed propulsion using M-DARs 131-136, 141-146. Arrays of multiple EDFs increase the maximum thrust to weight of the vehicle. This decreases the overall throttle and power level needed to stay in hover. This also adds redundancy into the system, adding increased safety and survivability in the event of partial propulsion system loss. A dynamic control system could be engineered to detect mechanical failures and compensate to maintain control with the existing EDFs. In an M-DAR configuration fans are generally rolled inward to create a vector component in the lateral axis. This component can also contribute to a yaw control, allowing an M-DAR arrangement to maintain control on the roll pitch and yaw axis, allowing for a controlled emergency descent if necessary.

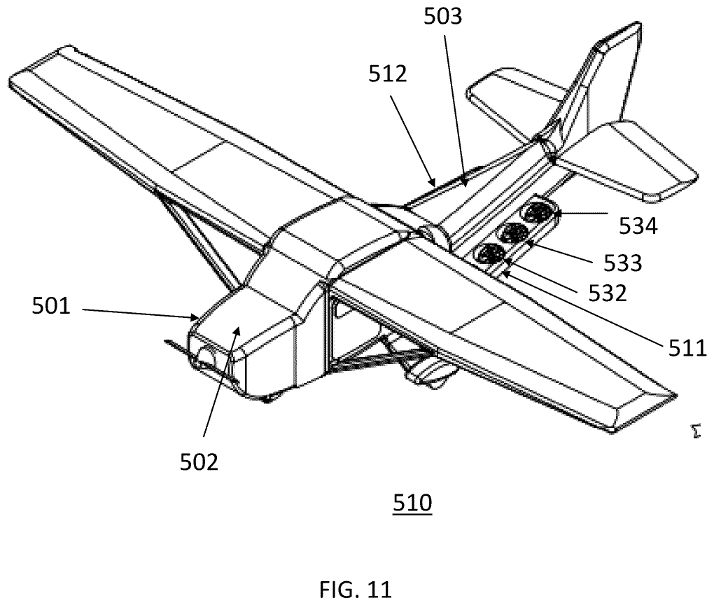

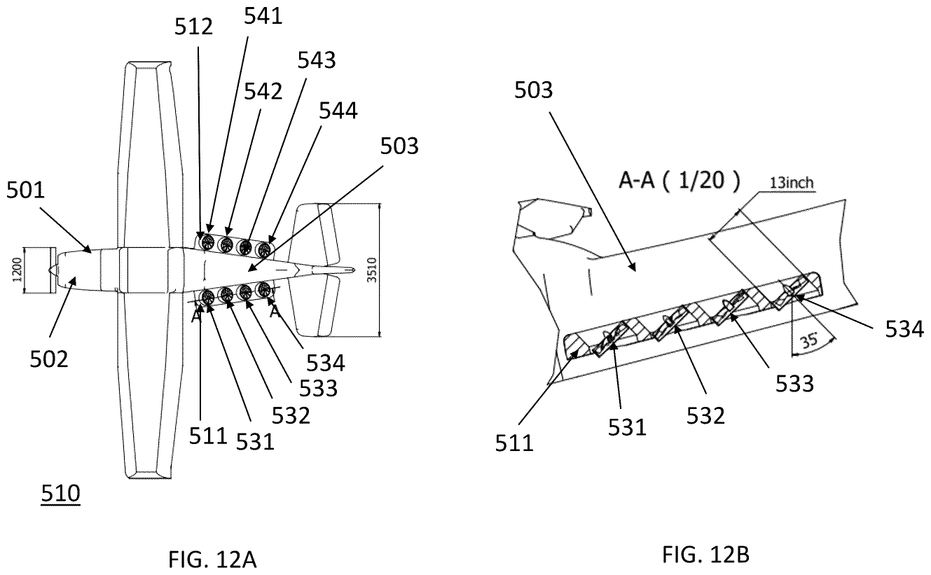

With reference to FIGS. 11 and 12A and 12B, an additional embodiment of the present invention is provided. FIGS. 11 and 12A and 12B show an aircraft 501 having a nose section 502 and a central rear fuselage section 503. The Chariot 510 would include a left pylon 511 and right pylon 512. The left pylon 511 would include a series of M-DAR units 531, 532, 533, 534 and a right pylon 512 with a series of right M-DAR units 541, 542, 543, 5444. The left pylon 511 and right pylon 512 are connected to each other by a “U” or “Y” shaped connector bridge. The connector bridge is designed to fit around the lower portion of the tail portion of the fuselage 503. The left and right pylons 511, 512 with the embedded M-DAR units 531-534, 541-544 connected by the bridge to form an accessory for assisting larger aircraft during takeoff or can assist during flight and landing. This alternative embodiment can be mechanically attached as a rigid attachment or could be configured with a releasable attachment.

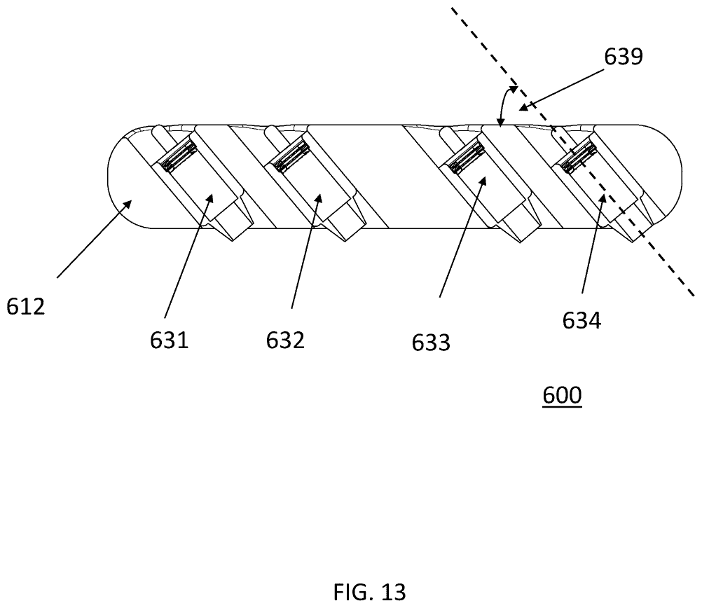

An alternative design to the use of M-DAR units is depicted in FIG. 13. As seen in FIG. 13, the present invention could employ a turbine or micro-turbine system 600. The turbine system 600 would include one or more turbines or micro-turbines 631, 632, 633, 634 embedded within a pylon 612. The turbines 631, 632, 633, 634 would be employed within ducts in a fixed forward position. The turbines 631, 632, 633, 634 would be positioned or fixed at a forward angle 650 within the housing of the pylon 612 typically between 30-70 degrees with most designs setting the forward position at 45-65 degrees from the horizontal.

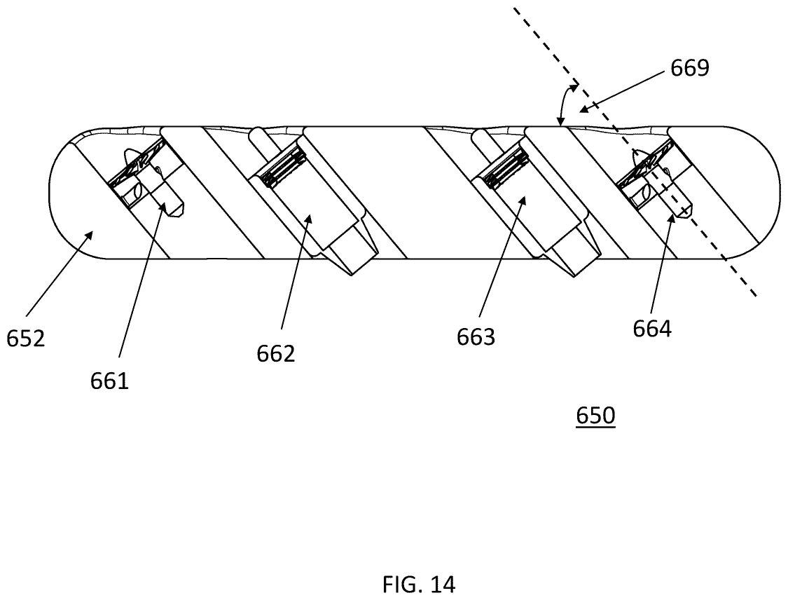

Further, as seen in FIG. 14, the present invention could employ a mix of M-DAR units 621, 664 and turbines 662, 663 within a pylon 652. The number of M-DAR units and turbines and their location within the pylon 652 can be determined by the operational parameters required. The M-DAR units 661, 664 and turbines 662, 663 would be positioned or fixed at a forward angle 669 within the housing of the pylon 652 typically between 30-70 degrees with most designs setting the forward position at 45-65 degrees from the horizontal.

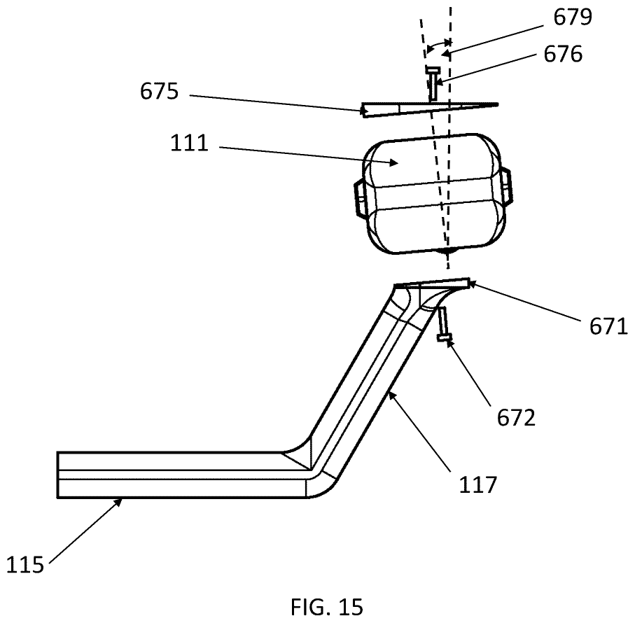

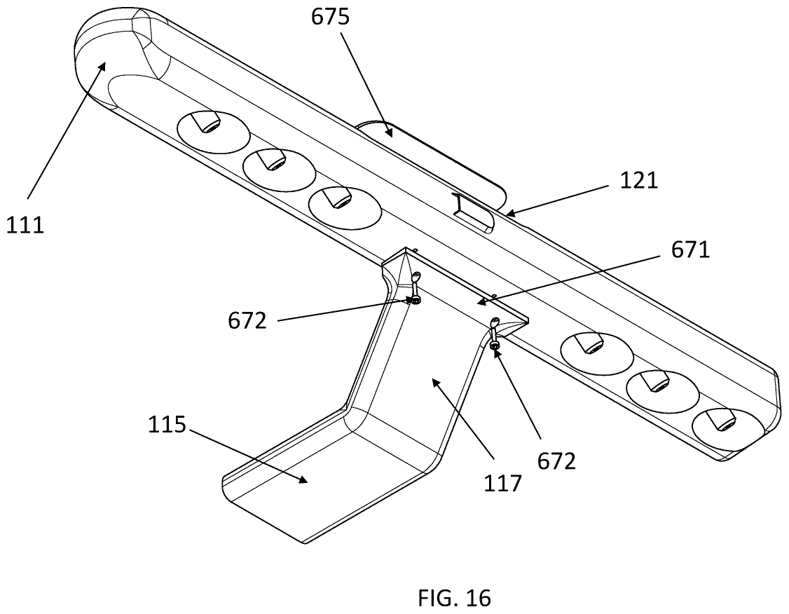

As seen in FIGS. 15 and 16, in combination with FIGS. 5A and 5B, the design of the Chariot 110 provides a modular design and straightforward method of assembly of the Chariot 110. The method of assembly includes attaching the left pylon 111 to the upper end of the left arm 117 of the truss assembly and connecting the right pylon 112 to the upper end of the right arm 118 of the truss assembly. The bridge 115 of the truss assembly can be connected to the lower end of the left arm 117 and lower end of the right arm 118. The bridge 115, left arm 117 and right arm 118 can also be one unit. The multi-ducted angled rotors, or motors, within the left pylon 111 and right pylon 11, in addition to the fixed angled forward position, may have a slight angle inward so that the exhaust of the multi-ducted angled rotors is directed away from the Chariot 110. The inward angle, in a preferred embodiment, would be 3-5 degrees but could be larger or smaller. The inward angle also helps with Roll and Yaw control of the Chariot 110.

As seen in FIGS. 15 and 16, an alternative embodiment of the present invention can use pylons 111 (pylon 112 not shown) having multi-ducted angled rotors or motors with a forward angle but without an inward angle and could incorporate an arm to pylon mounting connector 671 which angles the pylon 111 inward. As seen in FIGS. 15 and 16, the arm to pylon connector 671 utilizes a wedge shape to set the pylon 111 with an inward angle. The arm to pylon connector 671 would be sized to provide an inward angle 679 of 3-5 degrees but could be larger or smaller to create a larger or smaller angle. The right-side arm 118 to right pylon 112 would have a corresponding or similar wedge connector to angle the right pylon 112 inward. The arm to pylon connector 671 is preferably connected to the bottom surface of the pylon 111 but could be designed to connect to an inner or outer sidewall of the pylon 111. The arm to pylon connector 671 could be connected to the pylon 111 by one or more mechanical fasteners 672.

Further, the design could employ a top plate 675 with a similar corresponding wedge like shape to make the planar wing mating surface 121 on the top surface of the pylon 111 generally horizontal to assist in mating the left wing 103 of the DAC 101 to the planar wing mating surface 121 of pylon 111 or the upper surface of the top plate 675. Pylon 112 would have a corresponding wedge shape to make the planar mating surface 122 on the top surface of pylon 112 generally horizontal to assist in mating the right wing 104 of the DAC 101 to the planar wing mating surface 122 of pylon 112 or the top surface of the top plate. An additional benefit of using the arm to pylon wedge connector 671 is that the pylons 111, 112 would be interchangeable since both the left pylon 111 and right pylon 112 would be identical. The interchangeable nature of the pylons 111, 112 would allow one of the pylons 111, 112 to be easily replaced if there is any issue with one of the pylons 111, 112. The method of assembly in the embodiment depicted in FIG. 15 includes connecting the arm to pylon wedge connector 671 to be mounted to the underside of the pylon 111 by one or more connectors 672 and then connecting the top plate 675 to the top of the pylon by one or more connectors 676. In a similar fashion, the right-side arm 118 would have a corresponding wedge connector to connect to the right-side pylon 112 with a corresponding right side top plate.

### Modified or Expanded Pylons or In-Wing Motors

The Chariot 110 can also utilize larger pylons 111, 112 having more ducted fixed forward motors or units 131-36, 141-146 to provide more power capable of handling larger payloads or larger and heavier deployable aircraft. The Chariot 110 could incorporate two or more pylons 111, 112 on each side, meaning two pylons 111, 112 attached to each other on both the left and right side. Alternatively, the pylons 111, 112 could be designed as one pylon 111, 112 on the left and right side with more fixed forward ducted motors or units within the pylons 111, 112 by increasing the length (i.e., more motors in the same line) or increasing the width and having multiple rows or columns of motors.

Further, in an additional embodiment, the Chariot 110 could have wings and incorporate or embed the fixed forward angled motors in the wings. The fixed forward angled motors embedded in the wings could utilize the shape of the wings to determine the number of motors to use.

### Artificial Intelligence

The present invention can also implement artificial intelligence (“AI”) technology including tactical AI. AI can be used to build or enhance the capabilities of the aircraft to provide a high-performance, trustable, bounded autonomy through the development of a modular, hierarchical, hybrid artificial intelligence system. As an enabling technology, the AI powered system can provide the following benefits: (1) implementing a novel mix of expert systems with module-specific deep reinforcement learning (DRL) techniques, realizing high performance in complex environments while allowing for rapid prototyping and incorporation of expert domain knowledge; (2) utilization of a comprehensive modular design, allowing for improvements to sensors and individual capabilities without costly retraining of higher-level behaviors; (3) realization of several orders of magnitude in savings on required training and execution compute resources, saving training cost and time while providing operational responsiveness; (4) providing high-quality, human relevant insight into perception, decisions, and execution while enabling explicit, verifiable compliance with internally and externally imposed safety and operational limits; (5) utilization of containerized development techniques as part of an overall design approach with clearly defined interfaces, providing simple integration to a variety of simulation environments (i.e., AFSIM, AirSim, JSBSim, Unity, Unreal, CORE, etc.) and platforms (i.e., DroneCode/MAVLINK, FACE, OMS, etc.).

The AI system can provide the following functions: (1) autonomous or optionally-manned basic vehicle operation, performing administrative and navigation tasks in order to decrease operator workload, increase vehicle-to-operator ratio, and improve operational availability by decoupling vehicle performance from crew requirements; (2) autonomous low-level operation for threat avoidance and mission flexibility including both automatic ground collision avoidance systems as well as advanced optical and LIDAR based obstacle avoidance; (3) autonomous formation flight, with both dynamic formations and leader-follower flexibility which reduces the optical signature for multiple vehicles while complicating track formation by traditional air defense systems, formation maintenance and station keeping will enhance mission effectiveness while minimizing air traffic control requirements in permissive environments; and (4) enhanced threat assessment, auto-routing, and reactive mission execution through application of reinforcement learning.

By way of example, AI can be used in numerous applications ranging from autonomous navigation, establishment and maintenance of robust communication links, and control of simulated fighter aircraft in dogfight scenarios.

### Processor System

The processor system 300 of the present invention may be implemented as a system, method, apparatus or article of manufacture using programming and/or engineering techniques related to software, firmware, hardware, or any combination thereof. The described operations may be implemented as code maintained in a “computer readable medium”, where a processor may read and execute the code from the computer readable medium. A computer readable medium may comprise media such as magnetic storage medium (e.g., hard disk drives, floppy disks, tape, etc.), optical storage (CD-ROMs, DVDs, optical disks, etc.), volatile and non-volatile memory devices (e.g., EEPROMs, ROMs, PROMs, RAMs, DRAMs, SRAMs, Flash Memory, firmware, programmable logic, etc.), etc. The code implementing the described operations may be further implemented in hardware logic (e.g., an integrated circuit chip, Programmable Gate Array (PGA), Application Specific Integrated Circuit (ASIC), etc.). Furthermore, the code implementing the described operations may be implemented in “transmission signals”, where transmission signals may propagate through space or through a transmission media, such as an optical fiber, copper wire, etc. The transmission signals in which the code or logic is encoded may further comprise a wireless signal, satellite transmission, radio waves, infrared signals, Bluetooth, etc. The transmission signals in which the code or logic is encoded is capable of being transmitted by a transmitting station and received by a receiving station, where the code or logic encoded in the transmission signal may be decoded and stored in hardware or a computer readable medium at the receiving and transmitting stations or devices. An “article of manufacture” comprises computer readable medium, hardware logic, and/or transmission signals in which code may be implemented. A device in which the code implementing the described embodiments of operations is encoded may comprise a computer readable medium or hardware logic. Of course, those skilled in the art will recognize that many modifications may be made to this configuration without departing from the scope of the present invention, and that the article of manufacture may comprise suitable information bearing medium known in the art.

In an embodiment of the invention, the systems and methods may connect to or use networks, wherein, the term, ‘networks’ means a system allowing interaction between two or more electronic devices and includes any form of inter/intra enterprise environment such as the world wide web, Local Area Network (LAN), Wide Area Network (WAN), Storage Area Network (SAN) or any form of Intranet.

In an embodiment of the invention, the systems and methods can be practiced using any electronic device. An electronic device for the purpose of this invention is selected from any device capable of processing or representing data to a user and providing access to a network or any system similar to the internet, wherein the electronic device (such as a controller of the Chariot or the DAC) may be selected from but not limited to, personal computers, mobile phones, laptops, palmtops, tablets, radio controlled joystick, portable media players and personal digital assistants. As noted above, the processing systems may be a suitable computer or other processing machine. The processing machine may also utilize (or be in the form of) any of a wide variety of other technologies including a special purpose computer, a computer system including a microcomputer, mini-computer or mainframe for example, a programmed microprocessor, a micro-controller, a peripheral integrated circuit element, a CSIC (Consumer Specific Integrated Circuit) or ASIC (Application Specific Integrated Circuit) or other integrated circuit, a logic circuit, a digital signal processor, a programmable logic device such as a FPGA, PLD, PLA or PAL, or any other device or arrangement of devices that is capable of implementing the steps described herein.

The processing machine used to implement the invention may utilize a suitable operating system (OS). Thus, embodiments of the invention may include a processing machine running the Unix operating system, the Apple iOS operating system, the Linux operating system, the Xenix operating system, the IBM AIX™ operating system, the Hewlett-Packard UX™ operating system, the Novell Netware™ operating system, the Sun Microsystems Solaris™ operating system, the OS/2™ operating system, the BeOS™ operating system, the Macintosh operating system (such as macOS™), the Apache operating system, an OpenStep™ operating system, the Android™ operating system (and variations distributed by Samsung, HTC, Huawei, LG, Motorola, Google, Blackberry, among others), the Windows 10 ™ operating system, the Windows Phone operating system, the Windows 8 ™ operating system, Microsoft Windows™ Vista™ operating system, the Microsoft Windows™ XP™ operating system, the Microsoft Windows™ NT™ operating system, the Windows™ 2000 operating system, or another operating system or platform.

It is appreciated that in order to practice the method of the invention as described above, it is not necessary that the processors and/or the memories of the processing machine be physically located in the same geographical place. That is, each of the processors and the memories used by the processing machine may be located in geographically distinct locations and connected so as to communicate in any suitable manner, such as over a network of over multiple networks. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment or two pieces in two different physical locations.

The two distinct pieces of equipment may be connected in any suitable manner. Additionally, the memory may include two or more portions of memory in two or more physical locations. To explain further, processing as described above is performed by various components and various memories. However, it is appreciated that the processing performed by two distinct components as described above may, in accordance with a further embodiment of the invention, be performed by a single component. Further, the processing performed by one distinct component as described above may be performed by two distinct components. In a similar manner, the memory storage performed by two distinct memory portions as described above may, in accordance with a further embodiment of the invention, be performed by a single memory portion. Further, the memory storage performed by one distinct memory portion as described above may be performed by two memory portions.

Further, as also described above, various technologies may be used to provide communication between the various processors and/or memories, as well as to allow the processors and/or the memories of the invention to communicate with any other entity; i.e., so as to obtain further instructions or to access and use remote memory stores, for example. Such technologies used to provide such communication might include a network, the Internet, Intranet, Extranet, LAN, an Ethernet, or any client server system that provides communication, for example. Such communications technologies may use any suitable protocol such as TCP/IP, UDP, or OSI, for example.

Further, multiple applications may be utilized to perform the various processing of the invention. Such multiple applications may be on the same network or adjacent networks, and split between non-cloud hardware, including local (on-premises) computing systems, and cloud computing resources, for example. Further, the systems and methods of the invention may use IPC (interprocess communication) style communication for module level communication. Various known IPC mechanisms may be utilized in the processing of the invention including, for example, shared memory (in which processes are provided access to the same memory block in conjunction with creating a buffer, which is shared, for the processes to communicate with each other), data records accessible by multiple processes at one time, and message passing (that allows applications to communicate using message queues).

As described above, a set of instructions is used in the processing of the invention. The set of instructions may be in the form of a program or software. The software may be in the form of system software or application software, for example. The software might also be in the form of a collection of separate programs, a program module within a larger program, or a portion of a program module, for example. The software used might also include modular programming in the form of object oriented programming. The software tells the processing machine what to do with the data being processed.

Further, it is appreciated that the instructions or set of instructions used in the implementation and operation of the invention may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments of the invention. Illustratively, the programming language used may include assembly language, Ada, APL, Basic, C, C++, C#, Objective C, COBOL, dBase, Forth, Fortran, Java, Modula-2, Node.JS, Pascal, Prolog, Python, REXX, Visual Basic, and/or JavaScript, for example. Further, it is not necessary that a single type of instructions or single programming language be utilized in conjunction with the operation of the system and method of the invention. Rather, any number of different programming languages may be utilized as is necessary or desirable.

Also, the instructions and/or data used in the practice of the invention may utilize any compression or encryption technique or algorithm, as may be desired. An encryption module might be used to encrypt data. Further, files or other data may be decrypted using a suitable decryption module, for example.

As described above, the invention may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in the invention may take on any of a variety of physical forms or transmissions, for example. Illustratively, as also described above, the medium may be in the form of paper, paper transparencies, a compact disk, a DVD, an integrated circuit, a hard disk, a floppy disk, an optical disk, a magnetic tape, a RAM, a ROM, a PROM, a EPROM, a wire, a cable, a fiber, communications channel, a satellite transmissions or other remote transmission, as well as any other medium or source of data that may be read by the processors of the invention.

Further, the memory or memories used in the processing machine that implements the invention may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the system and method of the invention, a variety of “user interfaces” may be utilized to allow a user to interface with the processing machine or machines that are used to implement the invention. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, voice reader, voice recognizer, dialogue screen, menu box, list, checkbox, toggle switch, a pushbutton or any other device that allows a user to receive information regarding the operation of the processing machine as it processes a set of instructions and/or provide the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method of the invention, it is not necessary that a human user interact with a user interface used by the processing machine of the invention. Rather, it is also contemplated that the user interface of the invention might interact, i.e., convey and receive information, with another processing machine, rather than a human user. Accordingly, the other processing machine might be characterized as a user. Further, it is contemplated that a user interface utilized in the system and method of the invention may interact partially with another processing machine or processing machines, while also interacting partially with a human user.

While the foregoing description and drawings represent preferred or exemplary embodiments of the present invention, it will be understood that various additions, modifications and substitutions may be made therein without departing from the spirit and scope and range of equivalents of the accompanying claims. In particular, it will be clear to those skilled in the art that the present invention may be embodied in other forms, structures, arrangements, proportions, sizes, and with other elements, materials, and components, without departing from the spirit or essential characteristics thereof. In addition, numerous variations in the methods/processes as applicable described herein may be made without departing from the spirit of the invention. One skilled in the art will further appreciate that the invention may be used with many modifications of structure, arrangement, proportions, sizes, materials, and components and otherwise, used in the practice of the invention, which are particularly adapted to specific environments and operative requirements without departing from the principles of the present invention. The presently disclosed embodiments are therefore to be considered in all respects as illustrative and not restrictive, the scope of the invention being defined by the appended claims and equivalents thereof, and not limited to the foregoing description or embodiments. Rather, the appended claims should be construed broadly, to include other variants and embodiments of the invention, which may be made by those skilled in the art without departing from the scope and range of equivalents of the invention.

What is claimed is:

1. A vehicle for assisting a deployable aircraft with vertical take-off and/or landing (VTOL), comprising:
a left pylon containing a plurality of left side multi-ducted angled rotors embedded in the left pylon;
a right pylon containing a plurality of right side multi-ducted angled rotors embedded in the right pylon;
a connecting truss connecting the left pylon to the right pylon, the connecting truss including:
a lower planar bridge, a left side arm, and a right side arm;
wherein the left side of the lower planar bridge is connected to a left arm lower end of a the left side arm and the right side of the lower planar bridge is connected to a right arm lower end of the right-side arm;
wherein a left arm upper end is connected to the left pylon;
wherein a right arm upper end is connected to the right pylon;
wherein the connecting truss is located below a left side upper surface of the left pylon and a right-side upper surface of the right pylon to create an opening between the left pylon and right pylon; and
wherein the deployable aircraft mates with the left side upper surface of the left pylon and the right-side upper surface of the right pylon and a fuselage of the deployable aircraft fits within the opening between the left side pylon and right-side pylon.

2. The vehicle of claim 1, further comprising a connection device for connecting the deployable aircraft to the vehicle.

3. The vehicle of claim 1, further comprising a processing system, wherein the processing system controls the plurality of left side multi-ducted angled rotors and the plurality of right side multi-ducted angled rotors to control flight of the vehicle.

4. The vehicle of claim 1, further comprising a communication unit for communicating with the deployable aircraft.

5. The vehicle of claim 1, further comprising a communication unit for communicating with the remote-control device.

6. The vehicle of claim 1, further comprising a communication unit for communicating with a remote computer.

7. The vehicle of claim 1, further comprising a left side planar mating surface on the left side upper surface of the left pylon and a right-side planar mating surface on the right-side upper surface of the right pylon.

8. The vehicle of claim 7, wherein a left wing of the deployable aircraft mates with the left side planar mating surface and a right wing of the deployable aircraft mates with the right-side planar mating surface.

9. The vehicle of claim 1, wherein the lower planar bridge is expandable.

10. The vehicle of claim 1, further comprising a left side riser connected to the left side upper end of the left arm and the left pylon and a right-side riser is connected to the right-side upper end of the right arm and the right pylon.

11. The vehicle of claim 1, wherein the vehicle performs a vertical takeoff with the deployable aircraft mated to the vehicle.

12. The vehicle of claim 11, wherein the vehicle drops away from the deployable aircraft when the deployable aircraft is released.

13. The vehicle of claim 1, further including a tether located between the left side pylon and right-side pylon for capturing the deployable aircraft in flight.

14. The vehicle of claim 1, wherein the vehicle does not have wings.

15. The vehicle of claim 1, where the vehicle does not have control surfaces.

16. A method of releasing a deployable aircraft using a vertical takeoff vehicle the method comprising:
mating the deployable aircraft to the vertical takeoff vehicle by:
placing a left wing of the deployable aircraft on a left side upper surface of a left pylon of the vehicle;
placing a right-side wing of the deployable aircraft on a right-side upper surface of a right pylon of the vehicle; and
placing a fuselage of the deployable aircraft fits within an opening between the left side pylon and right-side pylon;
wherein the left side pylon is connected to the right side pylon by a connecting truss below the left side pylon and right side pylon;
wherein the left pylon contains a plurality of left side angled motors embedded in the left pylon;
wherein the right pylon contains a plurality of right-side angled motors embedded in the right pylon;
initiating vertical takeoff of the vehicle by controlling the plurality of left side angled motors and the plurality of right side angled motors;
sensing, by at least one sensor, the altitude of the vehicle;
determining, by the vehicle, the altitude has achieved a pre-determined threshold; and
releasing the deployable aircraft by lowering the power provided by the plurality of left side angled motors and plurality of right-side angled motors allowing the vehicle to drop away from the deployable aircraft.

17. The method of claim 16, further comprising the steps of:
sensing, by the at least one sensor, an airspeed of the vehicle; and
determining, by the vehicle, the airspeed has achieved a pre-determined threshold.

18. The method of claim 16, further comprising the steps of:
releasing a connection device connecting the deployable aircraft to the vehicle.

19. The method of claim 16, wherein the plurality of left side angled motors and plurality of right-side angled motors are multi-ducted angled rotors.

20. The method of claim 16, wherein the plurality of left side angled motors and plurality of right-side angled motors are fixed angled turbines.

21. The method of claim 16, wherein the plurality of left side angled motors and plurality of right-side angled motors comprise both multi-ducted angled rotors and fixed angled turbines.

22. The method of claim 16, wherein the release of the deployable aircraft is based on receiving a communication signal by a communication unit of the vehicle.

23. The method of claim 22, wherein the communication is received from the deployable aircraft, a remote control, or a remote computer.

24. A method of capturing an aircraft in flight using a vertical landing vehicle the method comprising:
initiating vertical takeoff of the vehicle by controlling a plurality of left side angled motors embedded in a left pylon and a plurality of right-side angled motors embedded in a right pylon, wherein the left side pylon is connected to the right-side pylon by a connecting truss below the left side pylon and right side pylon;
controlling flight of the vehicle and at least one sensor of the vehicle to position the vehicle in front of and below the aircraft;
capturing the aircraft to the vertical landing vehicle in flight by:
mating a left wing of the aircraft on a left side upper surface of the left pylon of the vehicle; and
mating a right wing of the aircraft on a right-side upper surface of the right pylon of the vehicle;
connecting the aircraft to the vehicle by a connecting device.
